(19) United States
(12) Patent Application Publication
(10) Pub. No.: US 2018/0113007 A1
(43) Pub. Date: Apr. 26, 2018

(54) REFLECTIVE ABSOLUTE ENCODER SENSOR

(71) Applicant: Avago Technologies General IP (Singapore) Pte. Ltd., Singapore (SG)

(72) Inventors: Hai Sheng Leong, Kuala Lampur (MY); Choon Aun Chong, Bayan Lepas (MY); Weng Fei Wong, Bayan Lepas (MY)

(21) Appl. No.: 15/332,044

(22) Filed: Oct. 24, 2016

(51) Int. Cl. G01D 5/30; G01D 5/347

(52) U.S. Cl. CPC G01D 5/30; G01D 5/34776

(57) ABSTRACT

An optical encoder is disclosed. Specifically, a reflective encoder is disclosed that includes an emitter configured to emit light, a first detector configured to receive a first portion of the light emitted by the emitter and convert the received first portion of the light into one or more electrical signals, the received first portion of the light at least one of passing through and being reflected by an optical track of a coding element. The reflective encoder also includes a second detector configured to receive second portion of the light emitted by the emitter and convert the received second portion of the light into one or more electrical signals, the emitter is positioned between the first detector and the second detector such that a first light path between the emitter and first detector is approximately a same distance as a second light path between the emitter and the second detector.

### FIELD OF THE DISCLOSURE

The present disclosure is generally directed toward encoders and more specifically toward optical encoders.

### BACKGROUND

A rotary encoder, also called a shaft encoder, is an electro-mechanical device that converts the angular position of a shaft or axle to an analog or digital code, making it an angular transducer. Rotary encoders are used in many applications that require precise shaft unlimited rotation—including industrial controls, robotics, special purpose photographic lenses, computer input devices (such as opto-mechanical mice and trackballs), printers, and rotating radar platforms. There are two main types of rotary encoders: absolute and incremental (relative).

An incremental rotary encoder, also known as a quadrature encoder or a relative rotary encoder, traditionally has two outputs called quadrature outputs. These two outputs can be either mechanical or optical. In the optical type, there are traditionally two bar-window coded tracks, while the mechanical type has two contacts that are actuated by cams on the rotating shaft. Optical incremental encoders traditionally employ two outputs called A & B, which are called quadrature outputs, as they are 90 degrees out of phase.

A variation on the incremental encoder is the sinewave encoder. Instead of producing two quadrature square waves, the outputs are quadrature sine waves (a Sine and a Cosine). By performing the arctangent function, arbitrary levels of resolution can be achieved.

A typical two-channel incremental encoder generates at its output two chains of pulses shifted by 90 degrees. By counting pulses and checking the phase between the pulses (1st channel leading 2nd or vice versa), it is possible to determine the speed and direction of rotation. A significant improvement to a two-channel incremental encoder is a three-channel incremental encoder. The extra channel is index: once per revolution a pulse is generated, it serves as zero position reference so that incremental angular position might be then calculated.

When working with rotary encoders, radial alignment is needed to ensure the code wheel pattern matches with the photodetector pattern on detector Integrated Circuit (IC). The gap between the detector and code wheel determines the optical contrast of the image formed by code wheel pattern. The nearer the gap, the better optical contrast is and the better dynamic performance of the encoder. However, if the gap is too small, there is a risk of code wheel scratch during operation, especially when the code wheel wobble during rotation. As a result, the gap must be set accurately.

### BRIEF DESCRIPTION OF THE DRAWINGS

The present disclosure is described in conjunction with the appended figures:

FIG. 1A is a side view depicting components of an optical encoder having a first configuration in accordance with embodiments of the present disclosure;

FIG. 1B is an isometric view of the encoder from FIG. 1A;

FIG. 2A is a side view depicting components of an optical encoder having a second configuration in accordance with embodiments of the present disclosure;

FIG. 2B is an isometric view of the encoder from FIG. 2A;

FIG. 3A is a side view depicting components of an optical encoder having a third configuration in accordance with embodiments of the present disclosure;

FIG. 3B is an isometric view of the encoder from FIG. 3A;

FIG. 4 is a detailed side view of an optical encoder having a fourth configuration in accordance with embodiments of the present disclosure;

FIG. 5A is a side view depicting components of an optical encoder having a fifth configuration in accordance with embodiments of the present disclosure;

FIG. 5B is an isometric view of the encoder from FIG. 5A;

FIG. 6A is a side view depicting components of an optical encoder having a sixth configuration in accordance with embodiments of the present disclosure;

FIG. 6B is a detailed side view of the encoder from FIG. 6A;

FIG. 6C is an isometric view of the encoder from FIG. 6A;

FIG. 7A is a detailed side view of an encoder having a seventh configuration in accordance with embodiments of the present disclosure;

FIG. 7B is a detailed side view of an encoder having an eighth configuration in accordance with embodiments of the present disclosure;

FIG. 8A is a detailed side view of an encoder having a ninth configuration in accordance with embodiments of the present disclosure;

FIG. 8B is a detailed side view of an encoder having a tenth configuration in accordance with embodiments of the present disclosure;

FIG. 9 is a flow chart depicting a method of operating an optical encoder in accordance with embodiments of the present disclosure; and

FIG. 10 is a block diagram depicting components of a for translating physical motion of a device into an electrical signal.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

Although embodiments of the present disclosure will be described in connection with optical encoders, it should be appreciated that embodiments of the present disclosure are not limited strictly to optical encoders or encoders of a certain type (e.g., rotary, linear, etc.). In particular, embodiments of the present disclosure can be applied to any type of device used to track the physical motion of a body. Further still, embodiments of the present disclosure can also be applied to similar optical systems that are not necessarily included in an encoder.

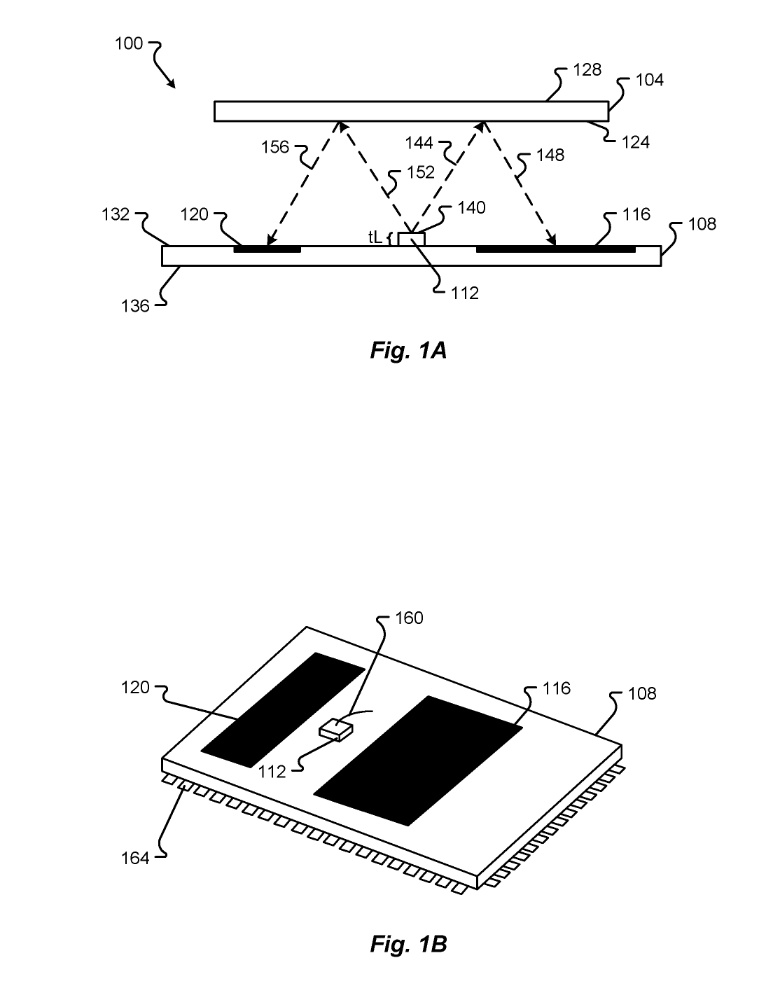

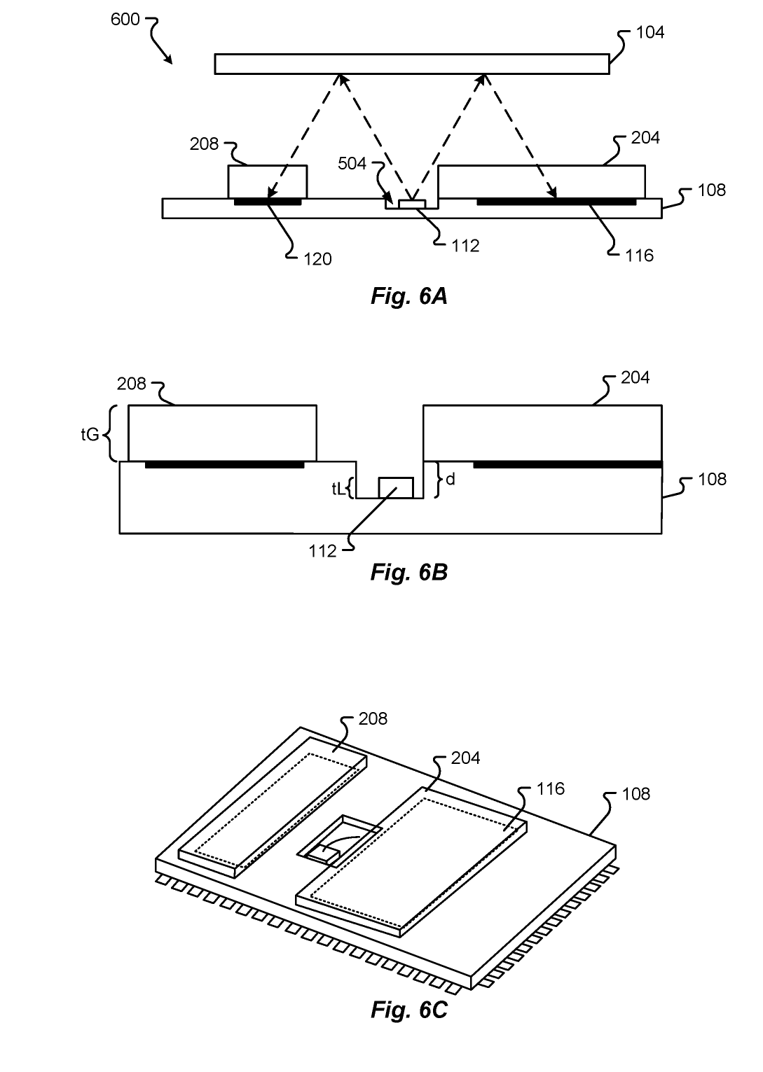

Embodiments of the present disclosure will be described in connection with various possible configurations of an optical encoder. With reference to FIGS. 1-10, features from these various possible configurations of an optical encoder will be described. It should be appreciated that the features from one configuration can be used in another configuration and vice versa. As a non-limiting example, features described in connection with FIGS. 1A-5B can be used in an optical encoder having one or more features from the configurations of FIGS. 6A-8B. Said another way, any combination of features from any encoder configuration depicted and described herein can be provided in another different encoder configuration even if that particular combination of figures is not specifically depicted or described.

Referring now to FIGS. 1A and 1B, components of an optical encoder 100 having a first configuration will be described in accordance with embodiments of the present disclosure. The illustrated optical encoder 100 corresponds to a reflective-type of optical encoder in that emitted light 144, 152 reflects from a reflective surface 124 of a coding element 104 and the reflected light 148, 156 is sensed at light detectors 116, 120. The depicted encoder 100 is specifically shown to include a coding element 104 distanced away from an Integrated Circuit (IC) 108 on which a light emitter 112, a first light detector 116, and a second light detector 120 are provided.

The coding element 104 may be provided in the form of a code wheel or a code strip—depending upon whether linear or rotary motion of a body is desired to be detected. The coding element 104, as is known in the encoder arts, may include a first surface 124 that is reflective (partially or completely) and an opposing second surface 128. The first surface 124 may have alternating areas of reflective and non-reflective (e.g., absorbing) material. In some embodiments the reflective material provided on the first surface 124 may correspond to a coating or a substrate that is physically coupled to the coding element 104. In some embodiments, the reflective material of the first surface 124 is deposited onto the coding element 104 using any type of known material deposition technique. In general, the coding element 104 includes an optical track of non-reflective sections (which may also be referred to as bars) and reflective sections (which may also be referred to as windows). The optical track may further comprise an index bar, which may also be non-reflective but is larger in area than the other non-reflective sections. The alternating reflective and non-reflective areas may enable the detection of physical movement of the coding element 104 relative to the IC 108, thereby enabling detection of relative and absolute movement of a body (e.g., a motor, shaft, etc.) to which the coding element 104 is coupled.

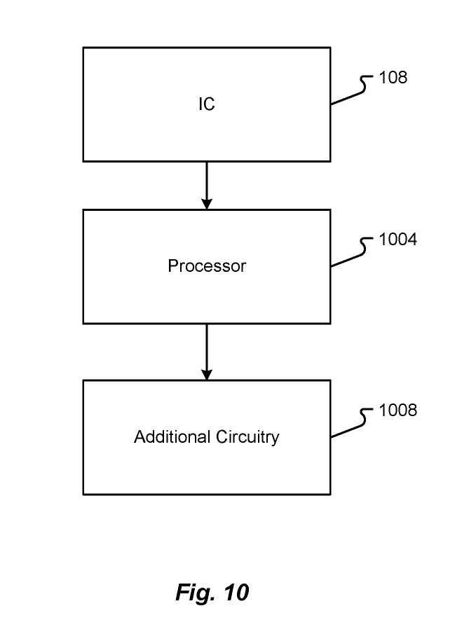

The emitter 112 produces light that is incident on the coding element 104. As the coding element 104 moves (e.g. is rotated, for example by a motor shaft (not shown)), the incident light 144, 152 is not reflected by the non-reflective sections of the track, but is reflected by the reflective sections of the track. Thus, the light 144, 152 is reflected by the track in a modulated pattern (i.e., on-off-on-off . . . etc.). The detectors 116, 120 provided on the IC 108 detect the modulated, reflected light signal and, in response, generates one or more periodic channel signals as well as an index signal when the index section passes over the emitter 112. In one embodiment, these channel signals and index signal are then transmitted to a decoder or processor, which generates a count signal and potentially an index signal and transmits the generated signals to a microprocessor 1004 or additional circuitry 1008 (see e.g., FIG. 10).

The microprocessor 1004 or additional circuitry 1008 uses the count signal to evaluate the incremental movement of, for example, the motor shaft or other moving part to which the coding element 104 is coupled. The index signal is used to evaluate complete rotations of the motor shaft or moving part to which the coding element 104 is coupled. Utilization of incremental signal outputs and an index output enables a more accurate optical encoder 100 to be achieved.

In some embodiments, the first detector 116 may correspond to an area used for detecting absolute movement or position of the coding element 104 whereas the second detector 120 may be used for detecting incremental movement or position of the coding element 104. The first detector 116 and second detector 120 may include photosensitive areas on the IC 108 that convert incident light (e.g., photon energy) into electrical signals. Suitable examples of photosensitive areas 116, 120 may include photodiodes or an array of photodiodes.

The size of the photosensitive area of the first detector 116 may be the same as the size of the photosensitive area of the second detector 120. In other embodiments, the size of the photosensitive area of the first detector 116 may be larger than the size of the photosensitive area of the second detector 120 as depicted in FIGS. 1A and 1B. In some embodiments, a distance between a center of the light emitter 112 and a center of the first detector 116 may be the same distance between the center of the light emitter 112 and a center of the second detector 120, regardless of whether or not the detectors 116, 120 are the same size. In other words, an optical path of light emitted by the emitting surface 140 of the light emitter 112 may be the same to the center of the first detector 116 and the center of the second detector 120. This equidistance between the emitter 112 and each detector 116, 120 results in an even light intensity between the first detector 116 and the second detector 120. This also results in an even image quality between both detectors 116, 120. Said another way, a distance traveled by a first portion of emitted light 144 and the first portion of reflected light 148 may be the same distance traveled by a second portion of emitted light 152 and the second portion of reflected light 156.

In the depicted embodiment, the emitter 112 is positioned between the first detector 116 and the second detector 120. In situations where one detector is larger in surface area than the other (e.g., the first detector 116 has a larger surface area than the second detector 120), the emitter 112 may be positioned closer to an edge of the larger detector (e.g., the first detector 116). This facilitates the equal distancing between the emitter 112 and the centers of the detectors 116, 120. Furthermore, by placing the emitter 112 between the detectors 116, 120 an even light intensity distribution can be achieved between the detectors 116, 120. While each detector 116, 120 may be imaging a different portion of the coding element 104 (e.g., the first detector 116 will image a portion of the coding element 104 upon which the first portion of emitted light 144 is incident whereas the second detector 120 will image a portion of the coding element 104 upon which the second portion of the emitted light 152 is incident), there will be a substantially even image quality distribution between the detectors 116, 120. As can be seen in FIG. 1A, the emitter 112 may be mounted on the first surface 132 of the IC 108, which may correlate to the top surface or detecting surface of the detectors 116, 120. A linear distance between the first surface 132 and the emitting surface 140 of the emitter 112 may correspond to an emitter thickness tL. As will be discussed in further detail herein, the emitter thickness tL may be an important parameter to consider when designing the IC 108, the detectors 116, 120, and the distance between the emitter 112 and the centers of the detectors 116, 120.

In some embodiments, the emitter 112 includes a light source such as a light-emitting diode (LED), an array of LEDs, a VCSEL, or the like. For convenience, the emitter 112 is described herein as an LED, although other light sources, or multiple light sources, may be implemented. In one embodiment, emitter 112 is driven by a driver signal, VLED, through a current-limiting resistor, R_{L}, which is provided to the emitter 112 via a bonding wire 160. The bonding wire 160 may carry the driver signal from appropriate circuitry in the IC 108 to the emitter 112, thereby creating a voltage difference between the active layers in the emitter 112. The details of such driver circuits are well-known. Some embodiments of the emitter 112 also may include a lens aligned with the LED to direct the emitted light 144, 152 in a particular path or pattern. For example, the lens may focus the light 144, 152 onto the coding element 104.

The signals produced by the detectors 116, 120 are processed by a processor 1004 or other additional processing circuitry 1008 which generates one or more channel signals, CH_{A}, CH_{B}, and CH_{I}. In one embodiment, the detectors 116, 120 may also include one or more comparators (not shown) to generate the channel signals and index signal. For example, analog electrical signals from the detectors 116, 120 may be converted by the comparators to transistor-transistor logic (TTL) compatible, digital output signals. In one embodiment, these output channel signals may indicate count and direction information for the modulated, reflected light signal.

The processor 1004 and/or additional processing circuitry 1008 may be incorporated in the IC 108 or may be external to the IC 108. As shown in FIG. 1B, the IC 108 may include a plurality of leads 164 that enable the IC 108 to electrically communicate with other processors, circuits, and circuit components. As an example, the leads 164 may connect the IC 108 to a PCB or the like and other circuit components may also be connected to the PCB. Thus, the IC 108 may be part of a larger electrical system or circuit.

Additional details of emitters, detectors, and optical encoders, generally, may be referenced in U.S. Pat. Nos. 4,451,731, 4,691,101, 5,241,172, and 7,400,269, all of which are hereby incorporated herein by reference in their entirety.

Furthermore, although embodiments of the present disclosure are particularly directed toward a reflective optical encoder, it should be appreciated that similar optical encoder configurations can be utilized in a transmissive optical encoding system without departing from the scope of the present disclosure.

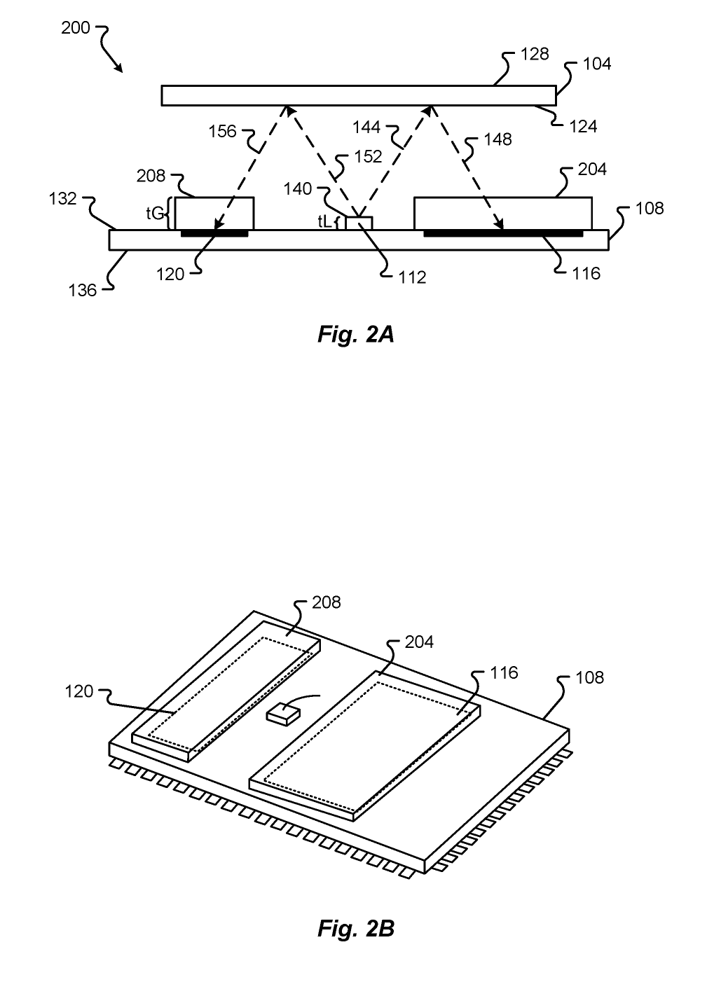

With reference now to FIGS. 2A and 2B, additional details of an optical encoder 200 having a second configuration will be described in accordance with at least some embodiments of the present disclosure. The encoder 200 is similar to encoder 100 and shares many features with encoder 100. The encoder 200 is also shown to include a first lid 204 and second lid 208 positioned over the first and second detectors 116, 120, respectively. In some embodiments, each lid 204, 208 may correspond to glass, plastic, or some other transparent material that enables light 148, 156 to pass therethrough and impact the detectors 116, 120. The lids 204, 208 may be sized sufficiently to cover all of the first and second detectors 116, 120, respectively. The dimensions of the lids 204, 208 are not limited to the extent of the detectors 116, 120, but rather can span the width and/or length of the IC 108 or any amount of distance therebetween. The shape of the lids 204, 208 do not necessarily have to be rectangular or square. For instance, the lids 204, 208 may have any type of shape including rectangular, square, round, or elliptical.

In some embodiments, the first lid 204 may correspond to a glass lid placed on top of the first detector 116 sufficient to completely cover and protect the light-detecting surface of the first detector 116. Accordingly, the first lid 204 may be placed on the first surface 132 of the IC 108. Similarly, the second lid 208 may correspond to a glass lid placed on top of the second detector 120 sufficient to completely cover and protect the light-detecting surface of the second detector 120. Like the first lid 204, the second lid 208 may be placed on the first surface 132 of the IC 108. In this way, the bottom surfaces of the lids 204, 208 are co-planar with the bottom surface of the emitter 112.

Unlike the emitter 112, the lids 204, 208 may have a thickness tG that is greater than the emitter thickness tL. Thus, the top surface of the lids 204, 208 may be closer to the coding element 104 than the emitting surface 140 of the emitter 112. The lids 204, 208, in some embodiments, help protect the detectors 116, 120 and also help to provide a degree of design freedom. In particular, if the lid thickness tG is properly controlled as compared to the emitter thickness tL, then it becomes possible to increase the tolerance of the encoder 200. More specifically, the working gap (e.g., distance between the coding element 108 and light-detecting surfaces of the detectors 116, 120) can be increased. Consider a non-limiting example. If an encoder is provided without lids 204, 208 as shown, then the working gap is determined by the emitter thickness tL entirely and may be on the order of approximately 0.3 um. However, if lids 204, 208 are utilized, then a larger working gap can be accommodated (e.g., on the order of 0.6 um). In other words, the working gap can possibly be doubled by incorporating the lids 204, 208 as shown in connection with encoder 200. Continuing the non-limiting example, if the emitter thickness tL is approximately 180 microns, then the lid thickness tG can be approximately between 500 microns and 600 microns. The lids 204, 208 substantially protect the detectors 116, 120 from being scratched by the coding element 104 during operation of the encoder 200. Advantageously, the lids 204, 208 do not negatively impact the optical paths of light 148, 156 travelling from the coding element 104 to the detectors 116, 120.

In some embodiments, it may be desirable to use a material for the lids 204, 208 that has a refractive index similar or identical to air or the gas contained between the coding element 104 and the IC 108. Using such a material can substantially inhibit light 148, 156 from bending or being redirected in an undesirable way. Although the lids 204, 208 are shown as being cube-shaped blocks with planar top surfaces, it should be appreciated that the top surfaces of the lids 204, 208 may be non-planar (e.g., may have one or more radiuses of curvature) without departing from the scope of the present disclosure.

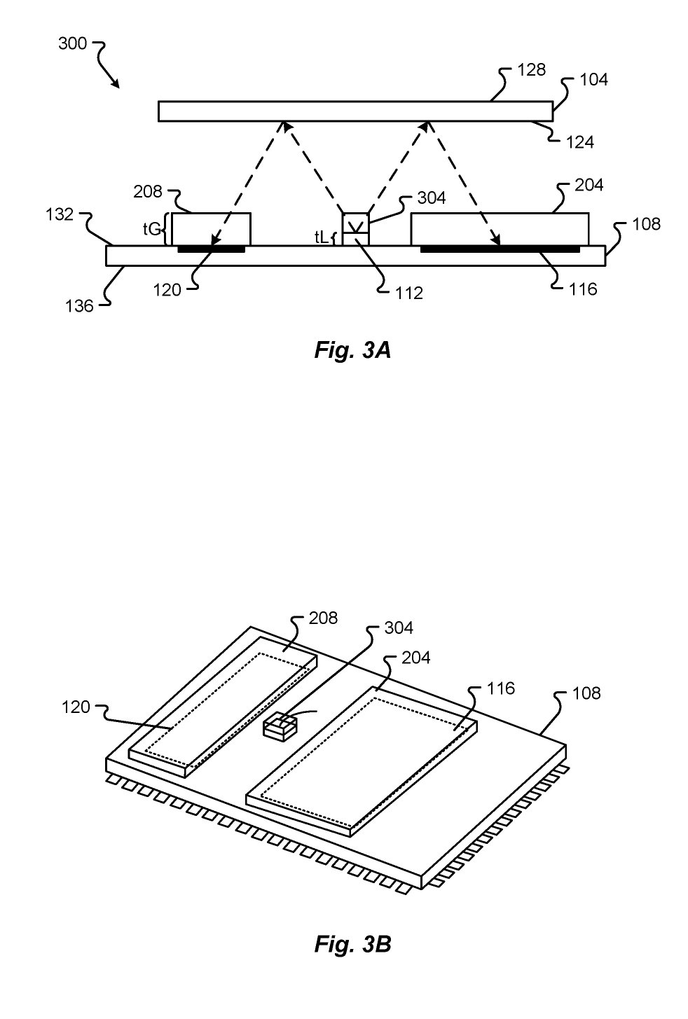

With reference now to FIGS. 3A and 3B, additional details of an optical encoder 300 having a third configuration will be described in accordance with at least some embodiments of the present disclosure. The encoder 300 is similar to encoders 100, 200 and shares many features with encoders 100, 200. The encoder 300 is different from encoders 100, 200 in that encoder 300 further includes a third lid 304 placed atop the emitting surface 140 of the emitter 112. In this particular embodiment, the third lid 304 is used to protect the emitter 112 from the coding element 104 and from other environmental dangers (e.g., dust, debris, etc.).

In some embodiments, the third lid 304 may comprise a thickness that, when added to the emitter thickness tL, is substantially equal to the lid thickness tG. In other words, the top surface of the third lid 304 may be substantially co-planar or parallel with the top surfaces of the first and second lids 204, 208. In other embodiments, the third lid 304 may have a thickness that, when added to the emitter thickness tL, is still less than the lid thickness tG. Thus, the top of the third lid 304 does not necessarily have to be co-planar with the tops of lids 204, 208.

The material used for the third lid 304 may be similar or identical to the materials used for the first lid 204 and second lid 208, although such a configuration is not required. In some embodiments, the third lid 304 includes a glass lid having a refractive index similar or identical to the refractive indices of the lids 204, 208. With use of two or more lids 204, 208, 304, the nominal working gap between the IC 108 and coding element 104 can be optimized for the optical encoder performance and without significant concern for damaging the detectors 116, 120 or emitter 112.

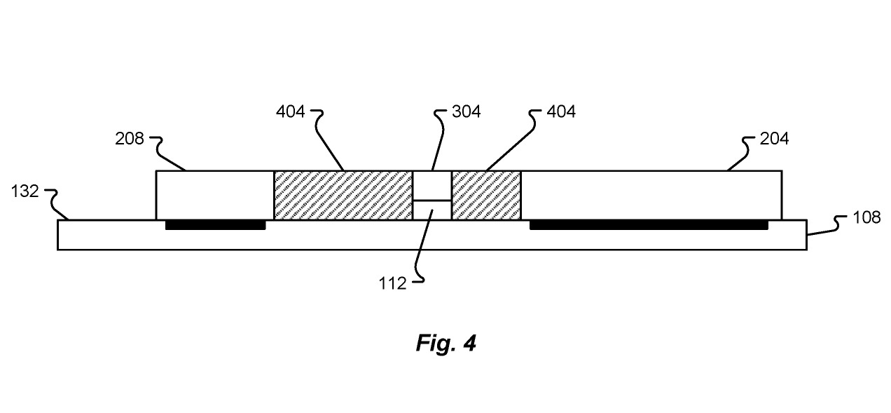

With reference now to FIG. 4, additional details of an optical encoder 400 having a fourth configuration will be described in accordance with at least some embodiments of the present disclosure. The encoder 400 is similar to encoders 100, 200, 300 and shares many features therewith. The encoder 400 is different from the other encoders 100, 200, 300 in that encoder 400 further includes an opaque mold compound 404 provided between the emitter 112 and the lids 204, 208. In some embodiments, the opaque mold compound 404 can be used to fill the spaces between the lids 204, 208, and/or 304. As an example, the opaque mold compound 404 may be provided on all of the first surface 132 of the IC 108 that is not covered by a lid 204, 208, 304. In other embodiments, the opaque mold compound 404 may simply be provided between the emitter 112 and the lids 204, 208. Such a positioning of the opaque mold compound 404 can facilitate the blockage of stray light travelling directly from the emitting surface 140 to the detectors 116, 120—which would effectively result in an introduction of noise to the encoder.

While the opaque mold compound 404 can be deposited on the IC 108 using any type of known technology, in some embodiments the opaque mold compound 404 is provided on the IC 108 using Film-Assisted Molding (FAM) techniques. Furthermore, although the opaque mold compound 404 is shown as being co-planar with the top surfaces of the lids 204, 208, 304, it should be appreciated that the opaque mold compound 404 may have a top surface that is higher than or lower than the top surfaces of the lids 204, 208, 304. In embodiments where a third lid 304 is not provided (e.g., as in encoder 200), then an opaque mold compound 404 may simply be provided with a thickness that is less than or equal to the emitter thickness tL, so as to not cover or impinge on the emitting surface 140. The third lid 304, as can be appreciated, enables the use of a thicker opaque mold compound 404, which further prevents cross-talk or stray light from travelling directly from the emitting surface 140 to the detectors 116, 120 without first reflecting from the coding element 104.

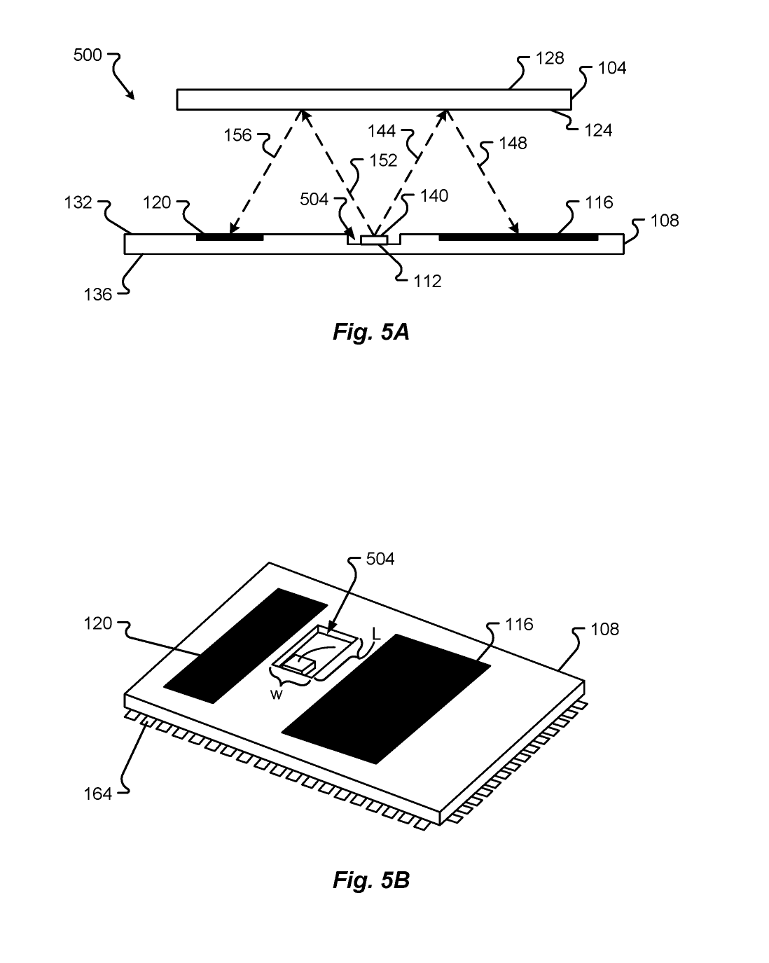

With reference now to FIGS. 5A and 5B, additional details of an optical encoder 500 having a fifth configuration will be described in accordance with at least some embodiments of the present disclosure. The encoder 500 is similar to encoders 100, 200, 300, 400 and shares many features therewith. The encoder 500 is different from other encoders 100, 200, 300, 400 in that encoder 500 further includes a cavity 504 in which the emitter 112 is positioned.

The cavity 500 is shown as being a depression or disruption in the first surface 132 of the IC 108. In some embodiments, the cavity 500 enables the emitter 112 to be positioned lower relative to the detectors 116, 120. Even more specifically, the cavity 500, if deep enough (e.g., having a depth that is greater than the emitter thickness tL), may position the emitting surface 140 of the emitter 112 as a position below the light-detecting surfaces of the detectors 116, 120. In this way, it may be possible to prevent light from travelling directly from the emitter 112 to the detectors 116, 120 without requiring the use of an opaque mold compound. For the configuration where the encoder 500 is provided with a cavity 504 but no lids, the minimum value for the depth of the cavity 504 should be approximately 1 um. Another embodiment of encoder 500 may have the depth of the cavity 504 be approximately equal to the emitter thickness tL, thereby resulting in the emitting surface 140 being substantially co-planar with the first surface 132 of the IC 108 and, therefore, the light-detecting surfaces of the detectors 116, 120.

As shown in FIG. 5B, the cavity 504 may have a defined width w and length L. In some embodiments, the width 2 of the cavity 504 can be as small as the width of the emitter 112 and can extend up to the allowable distance between the first detector 116 and the second detector 120.

With reference now to FIGS. 6A, 6B, and 6C, additional details of an optical encoder 600 having a sixth configuration will be described in accordance with at least some embodiments of the present disclosure. The encoder 600 is similar to encoders 100, 200, 300, 400, 500 and shares many features therewith. The encoder 600 is different from the other encoders 100, 200, 300, 400, 500 in that encoder 600 includes a combination of the cavity 504 and the lids 204, 208.

The cavity 504 is shown to have a depth d that is greater than the emitter thickness tL. It should be appreciated, however, that the depth d does not necessarily have to be greater than the emitter thickness tL. Although not shown, it should be appreciated that the cavity 504 can be filled with a transparent compound (e.g., silicone, transparent plastic, or some other encapsulant) or the cavity 504 may be left exposed to the surrounding environment as shown in the figures.

For cases where the encoder 600 is provided with lids 204, 208 and the cavity 504 and the emitter thickness tL is greater than the cavity depth d, then the lid thickness tG can be set to have a minimum dimension of twice the absolute value of the difference between the emitter thickness tL and the cavity depth d. In cases where the encoder 600 is provided with an emitter thickness tL that is less than the cavity depth d, the difference between the emitter thickness tL and the cavity depth d can be of any value. Furthermore, the lid thickness tG can be any value (e.g., less than the lid thickness tG if tL were greater than d). As a non-limiting example, the emitter thickness tL can be approximately 250 microns—a typical thickness of an LED. If the emitter thickness tL is less than or equal to the cavity depth d, then the lids 204, 208 can have a lid thickness tG that is less than 500 microns. In other words, it becomes possible to reduce the lid thickness tG by adjusting the cavity depth d, thereby treating the emitter 112 as if it were effectively thinner.

In some embodiments, the width w of the cavity 504 may also depend upon the size of the lids 204, 208. As shown in FIGS. 6A and 6B, a sidewall of the cavity 504 may be flush or coincident with a side wall of one or both lids (e.g., the first lid 204).

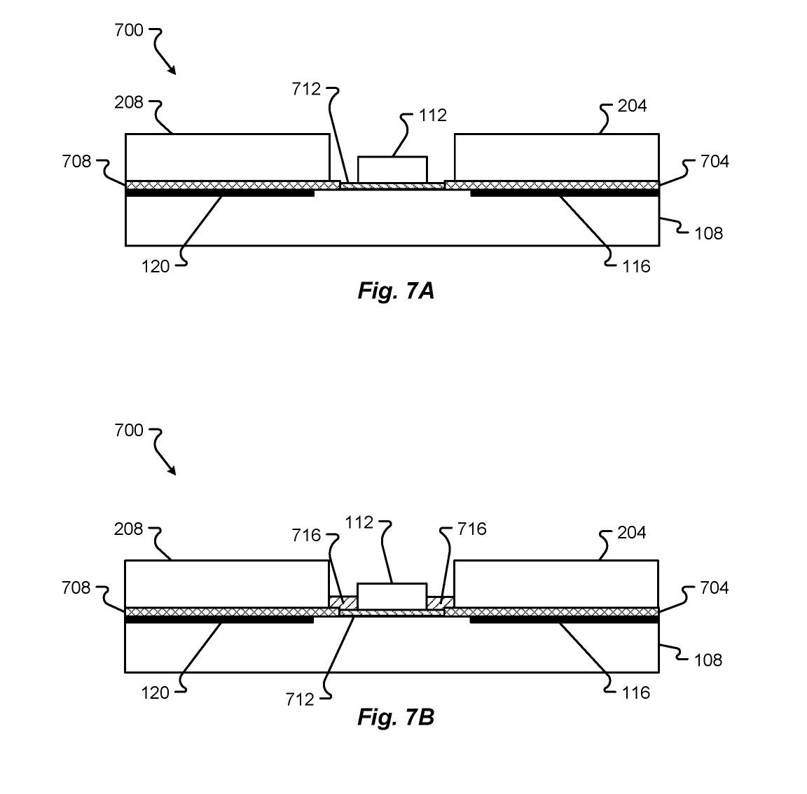

With reference now to FIGS. 7A and 7B, additional details of an optical encoder 700 having a seventh configuration will be described in accordance with at least some embodiments of the present disclosure. The encoder 700 is similar to encoders 100, 200, 300, 400, 500, 600 and shares many features therewith. The encoder 700 is shown to include a passivation layer having a first portion 704 and a second portion 708. The encoder 700 is also shown to include a bonding pad 712 on which the emitter 112 is bonded to the IC 108. FIG. 7B further depicts the encoder 700 as having an opaque mold compound 716 provided between the emitter 112 and the lids 204, 208.

In some embodiments, a bonding pad 712 may be provided (e.g., deposited on the first surface 132 of the IC 108) and then the passivation layer 704, 708 may be deposited on the remaining exposed portions of the first surface 132 of the IC 108. The passivation layer 704, 708 may extend and cover are larger area of the first surface 132 than the detectors 116, 120 or the lids 204, 208. In some embodiments, the passivation layer 704, 708 covers the entire first surface 132 of the IC 108 with the exception of the area covered by the bonding pad 712. The bonding pad 712 may provide a heat sink for the emitter 112 as well as a medium that adheres the emitter 112 to the IC 108. Although not typically substantial, the thickness of the bonding pad 712 may be accounted for in combination with the emitter thickness tL when determining an appropriate lid thickness tG.

The optional opaque mold compound 716 can be provided between the emitter 112 and the lids 204, 208 to further prevent cross-talk and other noise-inducing events. Specifically, the opaque mold compound 716 may be provided with a thickness between approximately 50% of the emitter thickness tL and 75% of the emitter thickness tL. In this way the emitting surface 140 of the emitter 112 is not covered, but light is substantially inhibited from directly travelling from the emitting surface 140 to most of the light-sensitive areas of the detectors 116, 120. The opaque mold compound 716 may be deposited on the IC 108 after the emitter 112 has been connected to the bonding pad 712 and after the lids 204, 208 have been positioned over the detectors 116, 120.

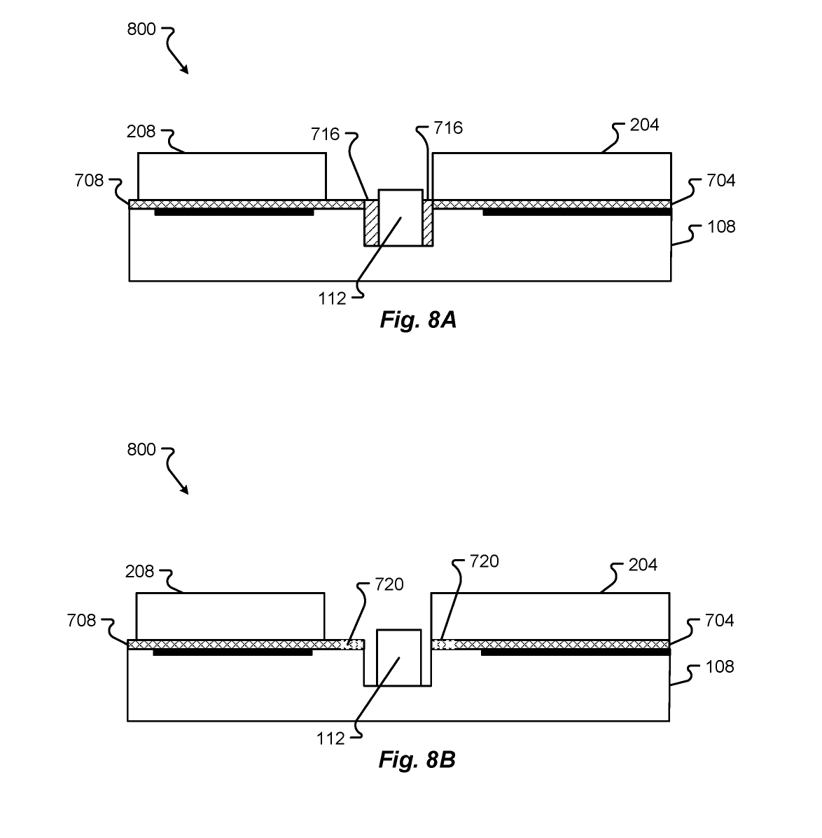

With reference now to FIGS. 8A and 8B, additional details of an optical encoder 800 having an eighth configuration will be described in accordance with at least some embodiments of the present disclosure. The encoder 800 is similar to encoders 100, 200, 300, 400, 500, 600, 700 and shares many features therewith. The encoder 800 is shown to include a cavity 504 in which the opaque mold compound 716 is provided. Furthermore, encoder 800 is shown to include the passivation layer 704, 708 that covers the first surface 132 of the IC 108, but does not fill the cavity 504. In this embodiment, the cavity depth d is less than the emitter thickness tL. In this situation, it may also be desirable to include one or more grooves 720 in the passivation layer 704, 708. More specifically, if the opaque mold compound 716 does not completely prevent a direct line of sight between the emitting surface 140 of the emitter 112 and the detectors 116, 120, then the grooves 720 provided in the passivation layer 704, 708 may further aid in the creation of a waveguide that prevents light from being guided through the remainder of the passivation layer 704, 708 and above the detectors 116, 120. The grooves 720 may structurally prevent light from travelling laterally through the passivation layer 704, 708 while still allowing reflected light 148, 156 to travel from the coding element 104 to the detectors 116, 120 (e.g., due to the more vertical direction of travel).

The opaque mold compound 716, in some embodiments, may also provide a mechanism for securing the emitter 112 within the cavity 504. Specifically, the opaque mold compound 716 may provide a material that protects the emitter and substantially prevents the emitter 112 from shifting in the cavity 504. While the opaque mold compound 716 is shown to be filled to a level that is flush with the top surface of the passivation layer 704, 708, it should be appreciated that the opaque mold compound 716 does not necessarily have to fill all of the cavity 504 (e.g., have a thickness equal to the cavity depth d). Rather, the opaque mold compound 716 may have a thickness that is greater than or less than the cavity depth d.

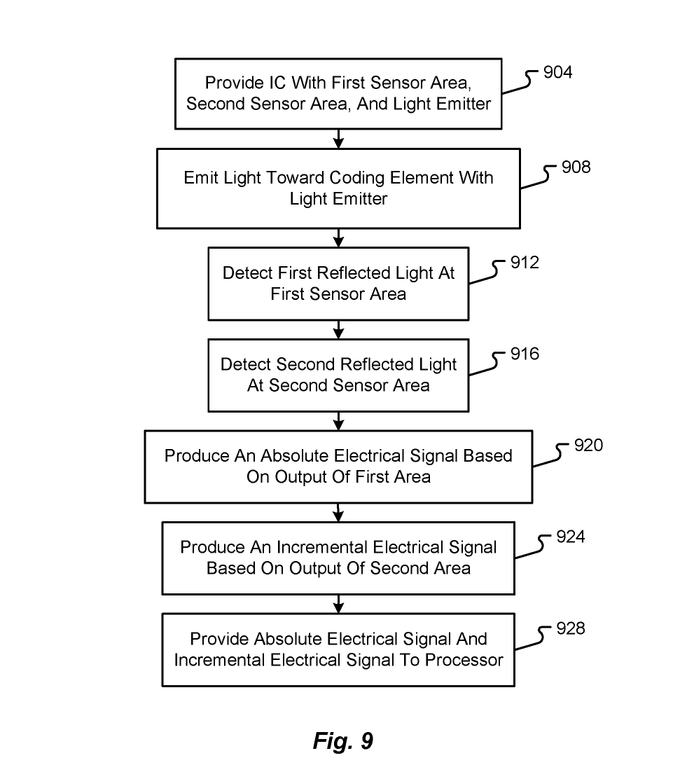

With reference now to FIG. 9, a method of operating an optical encoder will be described in accordance with at least some embodiments of the present disclosure. The method can be applied to any of the optical encoder configurations depicted and/or described herein.

The method begins by providing an IC 108 with a first light sensor area (e.g., a first detector 116), a second light sensor area (e.g., a second detector 120), and a light emitter 112 (step 904). The light emitter 112, in some embodiments, may be mounted on the first surface 132 of the IC 108 such that the bottom surface of the light emitter 112 is substantially co-planar with the light-detecting surfaces of the detectors 116, 120. In some embodiments, the detectors 116, 120 may be partially or completely covered with a lid 204, 208. Likewise, the emitter 112 may be partially or completely covered with a lid 304.

The method continues by enabling the emitter 112 to emit light 144, 152 toward the coding element 104 (step 908). The emitted light 144, 152 is reflected by the coding element 104. The method continues by detecting the first portion of reflected light 148 at the first sensor area/first detector 116 (step 912). The method also includes detecting the second portion of reflected light 156 at the second sensor area/second detector 120 (step 916). In some embodiments, steps 912 and 912 may be performed substantially simultaneously. While different portions of the coding element 104 may be imaged by the different sensor areas/detectors, the light intensity and image quality detected at each sensor area/detector may be substantially the same.

Based on the light detected at the first detector 116, the method proceeds by producing an absolute electrical signal (e.g., an electrical signal signifying an absolute position of the coding element 104 relative to the IC 108) based on an amount of light energy detected at the first detector 116 (step 920). Similarly, an incremental electrical signal (e.g., an electrical signal signifying an incremental position of the coding element 104 relative to the IC 108) may be produced based on an amount of light energy detected at the second detector 120 (step 924). Again, steps 920 and 924 may be performed substantially simultaneously. Moreover, it should be appreciated that the first detector 116 may be used to produce the incremental electrical signal whereas the second detector 120 may be used to produce the absolute electrical signal. Thereafter, the incremental and absolute electrical signals may be provided to a processor 1004 or other circuitry 1008 for further processing (step 928). These electrical signals may be provided via traces internal to the IC 108 and/or via the leads 164. Steps 908-928 may then be repeated to continuously monitor movement of the coding element 104 relative to the IC 108.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. An encoder for use in an optical encoding system, comprising:
an emitter configured to emit light;
a first detector configured to receive at least a first portion of the light emitted by the emitter and convert the received at least a first portion of the light into one or more electrical signals, wherein the received at least a first portion of the light at least one of passed through and was reflected by an optical track of a coding element; and
a second detector configured to receive at least a second portion of the light emitted by the emitter and convert the received at least a second portion of the light into one or more electrical signals, wherein the emitter is positioned between the first detector and the second detector such that a first light path between the emitter and first detector is approximately a same distance as a second light path between the emitter and the second detector.

2. The encoder of claim 1, further comprising:
an Integrated Circuit having a first surface and an opposing second surface, the first surface of the Integrated Circuit facing toward the coding element.

3. The encoder of claim 2, wherein the first detector and the second detector are both provided on the first surface of the Integrated Circuit, wherein the emitter is also provided on the first surface of the Integrated Circuit, and wherein the emitter is positioned between the first detector and the second detector.

4. The encoder of claim 3, wherein a light-detecting surface of the first detector is approximately co-planar with a light-detecting surface of the second detector.

5. The encoder of claim 4, further comprising:
a first lid positioned over the first detector such that the first light path passes through the first lid; and
a second lid positioned over the second detector such that the second light path passes through the second lid, wherein a thickness of the first lid and a thickness of the second lid are approximately equal and larger than a thickness of the emitter.

6. The encoder of claim 5, further comprising:
at least one passivation layer sandwiched between the first detector and the first lid and further sandwiched between the second detector and the second lid.

7. The encoder of claim 5, further comprising:
an opaque mold compound provided between the emitter and each of the first detector and second detector to substantially inhibit stray light from traveling directly from the emitter to either the first detector or the second detector without first passing through or reflecting off of the coding element.

8. The encoder of claim 3, wherein the first surface of the Integrated Circuit comprises a cavity formed therein that receives the emitter and wherein the cavity.

9. The encoder of claim 8, wherein a depth of the cavity is greater than a thickness of the emitter.

10. The encoder of claim 8, wherein a depth of the cavity is less than a thickness of the emitter such that a light-emitting surface of the emitter is positioned above light-detecting surfaces of the first detector and second detector.

11. The encoder of claim 2, further comprising:
a processor that utilizes the received at least a first portion of the light to determine an incremental position of the coding element relative to the Integrated Circuit and that utilizes the received at least a second portion of the light to determine an absolute position of the coding element relative to the Integrated Circuit.

12. The encoder of claim 1, wherein an image quality or intensity of the received at least a first portion of the light is substantially even with an image quality or intensity of the received at least a second portion of the light.

13. A system for translating physical motion of a device into an electrical signal, the system comprising:
an encoder comprising:
a first sensor area that includes an array of incremental photodiodes;
a second sensor area that includes an array of absolute photodiodes;
a light emitter positioned between the first sensor area and the second sensor area;
a coding element coupled to the device that receives light emitted by the light emitter and reflects at least some of the received light back toward the first sensor area and the second sensor area; and
signal processing circuitry coupled to the first sensor area and the second sensor area, the signal processing circuitry outputting an incremental signal and an absolute signal, wherein the incremental signal is generated based, at least in part, on electrical signals received at the signal processing circuitry from the first sensor area, wherein the absolute signal is generated based, at least in part, on electrical signals received at the signal processing circuitry from the second sensor area, wherein the incremental signal is indicative of an incremental position of the coding element relative to the first sensor area, and wherein the absolute signal is indicative of an absolute position of the coding element relative to the second sensor area.

14. The system of claim 13, wherein the encoder further comprises:
an Integrated Circuit on which the first sensor area, the second sensor area, and the light emitter are provided, the Integrated Circuit further having the signal processing circuitry included therein.

15. The system of claim 14, further comprising:
a first lid covering the first sensor area, the first lid comprising a first lid thickness; and
a second lid covering the second sensor area, the second lid comprising a second lid thickness that is substantially equal to the first lid thickness, wherein the first lid thickness and the second lid thickness are each at least twice a thickness of the light emitter.

16. The system of claim 14, wherein the Integrated Circuit comprises a cavity formed therein that is positioned between the first sensor area and the second sensor area and that receives the light emitter.

17. The system of claim 13, further comprising:
a passivation layer that covers the first sensor area and second sensor area; and
a mold compound positioned between the light emitter and at least one of the first sensor area and second sensor area so as to inhibit or prohibit light from travelling directly from the light emitter to the first sensor area or second sensor area.

18. The system of claim 13, wherein the light emitter is positioned equidistance between the first sensor area and the second sensor area.

19. A method of translating physical motion of a device into an electrical signal, the method comprising:
providing an Integrated Circuit with a first sensor area, a second sensor area, and a light emitter positioned between the first sensor area and the second sensor area;
causing the light emitter to emit light toward a coding element;
detecting first reflected light at the first sensor area, wherein the first reflected light traveled a first optical path from the light emitter, then to the coding element, and then to the first sensor area;
detecting second reflected light at the second sensor area, wherein the second reflected light traveled a second optical path from the light emitter, then to the coding element, and then to the second sensor area, wherein the first optical path and the second optical path are different;
producing an absolute electrical signal based, at least in part, on an electrical signal generated by the first sensor area in response to detecting the first reflected light; and
producing an incremental electrical signal based, at least in part, on an electrical signal generated by the second sensor area in response to detecting the second reflected light.

20. The method of claim 19, wherein a length of the first optical path is approximately equal to a length of the second optical path due to the light emitter being positioned approximately equidistance between the first sensor area and the second sensor area, wherein the first optical path passes through a first optically transparent material that covers the first sensor area, and wherein the second optical path passes through a second optically transparent material that covers the second sensor area.
